(19) United States
(12) Patent Application Publication
(10) Pub. No.: US 2022/0172584 A1
(43) Pub. Date: Jun. 2, 2022

(54) Remote Control Pager System

(71) Applicant: Rodney Waters, Bradenton, FL (US)

(72) Inventor: Rodney Waters, Bradenton, FL (US)

(21) Appl. No.: 17/108,098

(22) Filed: Dec. 1, 2020

(51) Int. Cl. G08B 3/10

(52) U.S. Cl. CPC G08B 3/1016

(57) ABSTRACT

A remote control pager system for preventing lost remote controls includes a pager apparatus and a remote control apparatus. The pager apparatus comprises a pager housing attached to a television. A pager transmitter is in operational communication with a pager battery and a pager button. The remote control apparatus comprises a remote housing. A microcontroller is coupled within the remote housing and is in operational communication with a plurality of remote batteries, a speaker, and a receiver. The receiver is in wireless communication with the pager transmitter to signal the speaker to emit a sound when the pager button is depressed. A remote transmitter is in wireless communication with the television. A plurality of control buttons is coupled to the remote housing and is in operational communication with the microcontroller.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to remote control paging devices and more particularly pertains to a new remote control paging device for preventing lost remote controls. The present invention includes a small paging device to be attached to the back of a TV and a universal remote with an integrated beeper in wireless communication with the paging device.

### (2) Description of Related Art Including Information Disclosed Under 37 CFR 1.97 and 1.98

The prior art relates to remote control paging devices. Known devices typically include a tracking device to attach to an existing remote rather than a universal remote with an integrated pager.

### BRIEF SUMMARY OF THE INVENTION

An embodiment of the disclosure meets the needs presented above by generally comprising a pager apparatus and a remote control apparatus. The pager apparatus comprises a pager housing having a pager front side, a pager back side, a pager left side, a pager right side, a pager top side, and a pager bottom side. The pager housing is configured to be attached to a television. A pager battery is coupled within the pager housing. A pager transmitter is coupled within the pager housing. The pager transmitter is in operational communication with the pager battery. A pager button is coupled to the pager housing. The pager button is in operational communication with the pager transmitter. The remote control apparatus comprises a remote housing having a remote front side, a remote back side, a remote left side, a remote right side, a remote top side, and a remote bottom side. A plurality of remote batteries is coupled within the remote housing. A microcontroller is coupled within the remote housing and is in operational communication with the plurality of remote batteries. A speaker is coupled to the remote housing and is in operational communication with the microcontroller. A receiver is coupled within the remote housing. The receiver is in operational communication with the microcontroller and in wireless communication with the pager transmitter to signal the speaker to emit a sound when the pager button is depressed. A remote transmitter is coupled within the remote housing and is in operational communication with the microcontroller. The remote transmitter is configured to be in wireless communication with the television. A plurality of control buttons is coupled to the remote housing and is in operational communication with the microcontroller.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a remote control pager system according to an embodiment of the disclosure.

FIG. 2 is a rear elevation view of an embodiment of the disclosure.

FIG. 3 is a rear elevation view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

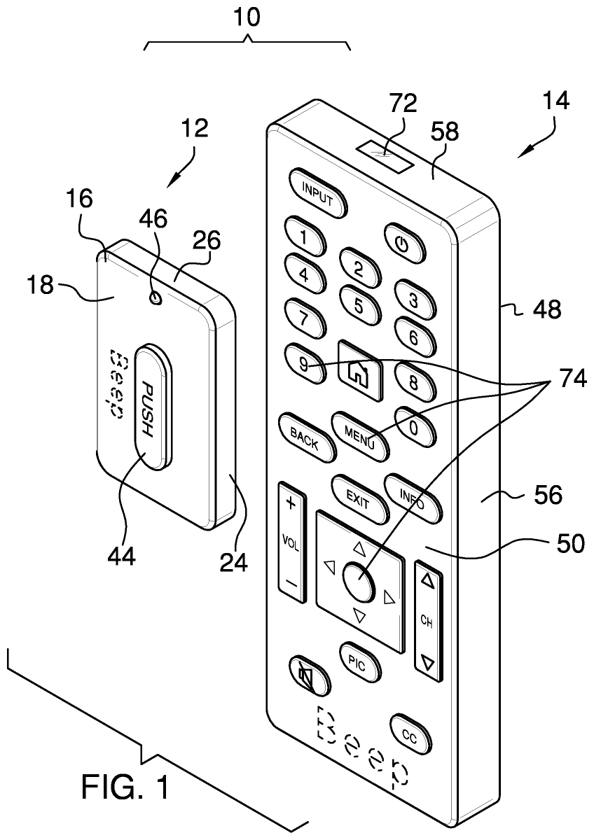

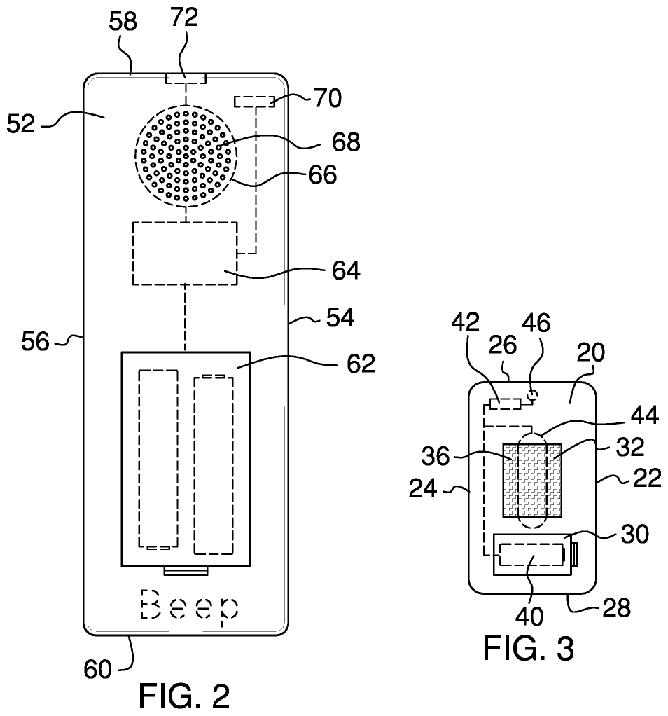

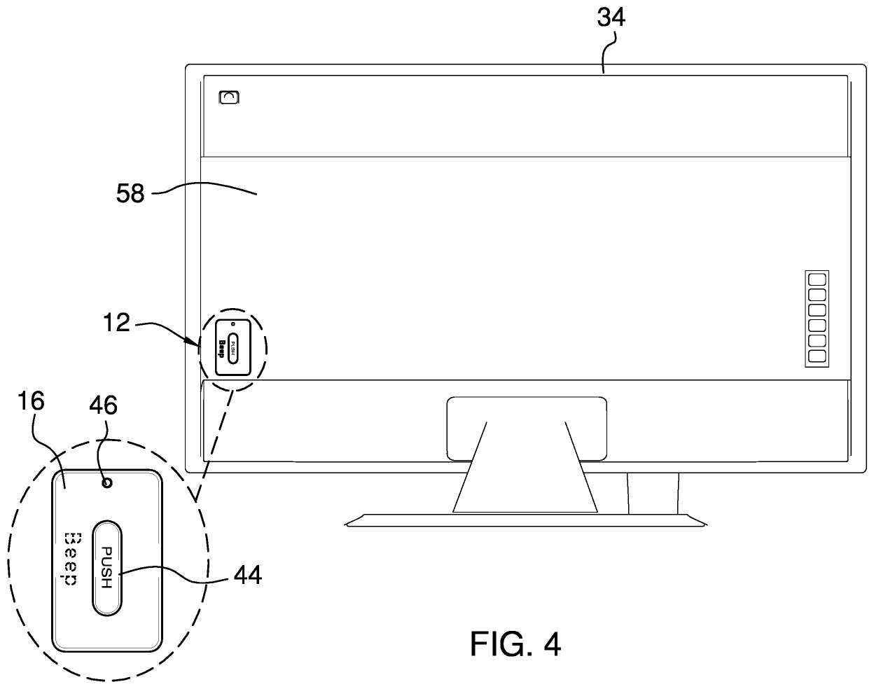

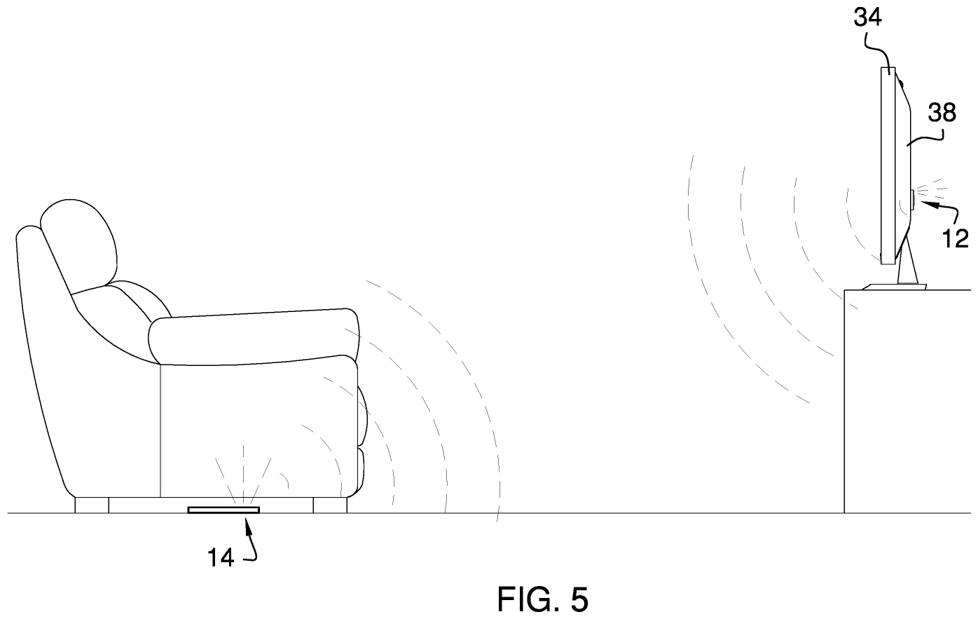

With reference now to the drawings, and in particular to FIGS. 1 through 5 thereof, a new remote control paging device embodying the principles and concepts of an embodiment of the disclosure and generally designated by the reference numeral 10 will be described.

As best illustrated in FIGS. 1 through 5, the remote control pager system 10 generally comprises a pager apparatus 12 and a remote control apparatus 14. The pager apparatus 12 comprises a pager housing 16 having a pager front side 18, a pager back side 20, a pager left side 22, a pager right side 24, a pager top side 26, and a pager bottom side 28. The pager housing 16 may be rectangular with rounded corners. The pager backside 20 may have a selectively removable pager battery cover 30. An engagement member 32 may be coupled to the pager housing 16. The engagement member 32 is configured to selectively engage the pager housing 16 with a television 34. The engagement member 32 may include a first engagement member half 36 coupled to the pager back side 20 and a second engagement member configured to be coupled to a television back side 38 of the television. The engagement member 32 may be a selectively engageable fastener such as, but not limited to, hook-and-loop fasteners, magnets, snaps, adhesives, and the like.

A pager battery 40 is coupled within the pager housing 16. The pager battery 40 is positioned adjacent the pager battery cover 30 for ease of replacement. A pager transmitter 42 is coupled within the pager housing 16 and is in operational communication with the pager battery 40. A pager button 44 is coupled to the pager housing 16. The pager button 44 may be obround and may protrude from the pager front side 18 for ease of location when placed on the television back side 38. The pager button 44 is in operational communication with the pager transmitter 42. A status light 46 may be coupled to the pager housing 16. The status light 46 is in operational communication with the pager transmitter 42 and may illuminate when the pager transmitter 42 is activated.

The remote control apparatus 14 comprises a remote housing 48 having a remote front side 50, a remote back side 52, a remote left side 54, a remote right side 56, a remote top side 58, and a remote bottom side 60. The remote back side 52 may have a selectively removable remote battery cover 62. A plurality of remote batteries 62 is coupled within the remote housing 48 adjacent the remote battery cover 62 for ease of replacement.

A microcontroller 64 is coupled within the remote housing 48 and is in operational communication with the plurality of remote batteries 62. A speaker 66 is coupled to the remote housing 48 and is in operational communication with the microcontroller 64. The speaker 66 may be coupled adjacent a speaker grille 68 extending through the remote back side 52. The speaker grille 68 maximizes the sound output by the speaker 66. A receiver 70 is coupled within the remote housing 48. The receiver 70 is in operational communication with the microcontroller 64 and in wireless communication with the pager transmitter 42 to signal the speaker 66 to emit a sound when the pager button 44 is depressed.

A remote transmitter 72 is coupled within the remote housing 48. The remote transmitter 72 is in operational communication with the microcontroller 64. The remote transmitter 72 is configured to be in wireless communication with the television 34. A plurality of control buttons 74 is coupled to the remote housing 48. The plurality of control buttons 74 is in operational communication with the microcontroller 64 to manipulate the television 34. The remote control apparatus 14 is universally programmable to function with any television 34.

In use, the pager button 44 is depressed in order to trigger the speaker 66 to emit a sound. The user may then easily locate the remote control apparatus 14 when misplaced or lost within couch cushions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remote control pager system comprising:
a pager apparatus comprising:
a pager housing, the pager housing having a pager front side, a pager back side, a pager left side, a pager right side, a pager top side, and a pager bottom side, the pager housing being configured to be attached to a television;
a pager battery coupled within the pager housing;
a pager transmitter coupled within the pager housing, the pager transmitter being in operational communication with the pager battery; and
a pager button coupled to the pager housing, the pager button being in operational communication with the pager transmitter; and
a remote control apparatus comprising:
a remote housing, the remote housing having a remote front side, a remote back side, a remote left side, a remote right side, a remote top side, and a remote bottom side;
a plurality of remote batteries coupled within the remote housing;
a microcontroller coupled within the remote housing, the microcontroller being in operational communication with the plurality of remote batteries;
a speaker coupled to the remote housing, the speaker being in operational communication with the microcontroller;
a receiver coupled within the remote housing, the receiver being in operational communication with the microcontroller and in wireless communication with the pager transmitter to signal the speaker to emit a sound when the pager button is depressed;
a remote transmitter coupled within the remote housing, the remote transmitter being in operational communication with the microcontroller, the remote transmitter being configured to be in wireless communication with the television; and
a plurality of control buttons coupled to the remote housing, the plurality of control buttons being in operational communication with the microcontroller.

2. The remote control pager system of claim 1 further comprising the pager apparatus including a status light coupled to the pager housing, the status light being in operational communication with the pager transmitter.

3. The remote control pager system of claim 1 further comprising the pager housing being rectangular with rounded corners.

4. The remote control pager system of claim 1 further comprising the pager apparatus including an engagement member coupled to the pager housing, the engagement member being configured to selectively engage the pager housing with the television.

5. The remote control pager system of claim 4 further comprising the engagement member including a first engagement member half coupled to the pager back side and a second engagement member configured to be coupled to a television back side of the television.

6. The remote control pager system of claim 1 further comprising the pager button being obround.

7. The remote control pager system of claim 1 further comprising the pager backside having a selectively removable pager battery cover; the remote back side having a selectively removable remote battery cover.

8. The remote control pager system of claim 1 further comprising the speaker being coupled adjacent a speaker grille extending through the remote back side.

9. A remote control pager system comprising:
a pager apparatus comprising:
a pager housing, the pager housing having a pager front side, a pager back side, a pager left side, a pager right side, a pager top side, and a pager bottom side, the pager housing being rectangular with rounded corners, the pager backside having a selectively removable pager battery cover;
an engagement member coupled to the pager housing, the engagement member being configured to selectively engage the pager housing with a television, the engagement member including a first engagement member half coupled to the pager back side and a second engagement member configured to be coupled to a television back side of the television;
a pager battery coupled within the pager housing;
a pager transmitter coupled within the pager housing, the pager transmitter being in operational communication with the pager battery;
a pager button coupled to the pager housing, the pager button being obround, the pager button being in operational communication with the pager transmitter; and
a status light coupled to the pager housing, the status light being in operational communication with the pager transmitter; and
a remote control apparatus comprising:
a remote housing, the remote housing having a remote front side, a remote back side, a remote left side, a remote right side, a remote top side, and a remote bottom side, the remote back side having a selectively removable remote battery cover;
a plurality of remote batteries coupled within the remote housing;
a microcontroller coupled within the remote housing, the microcontroller being in operational communication with the plurality of remote batteries;
a speaker coupled to the remote housing, the speaker being in operational communication with the microcontroller, the speaker being coupled adjacent a speaker grille extending through the remote back side;
a receiver coupled within the remote housing, the receiver being in operational communication with the microcontroller and in wireless communication with the pager transmitter to signal the speaker to emit a sound when the pager button is depressed;
a remote transmitter coupled within the remote housing, the remote transmitter being in operational communication with the microcontroller, the remote transmitter being configured to be in wireless communication with the television; and
a plurality of control buttons coupled to the remote housing, the plurality of control buttons being in operational communication with the microcontroller.

10. A remote control pager system and television combination comprising:
a television;
a pager apparatus comprising:
a pager housing, the pager housing having a pager front side, a pager back side, a pager left side, a pager right side, a pager top side, and a pager bottom side, the pager housing being rectangular with rounded corners, the pager backside having a selectively removable pager battery cover;
an engagement member coupled to the pager housing, the engagement member selectively engaging the pager housing with the television, the engagement member including a first engagement member half coupled to the pager back side and a second engagement member coupled to a television back side of the television;
a pager battery coupled within the pager housing;
a pager transmitter coupled within the pager housing, the pager transmitter being in operational communication with the pager battery;
a pager button coupled to the pager housing, the pager button being obround, the pager button being in operational communication with the pager transmitter; and
a status light coupled to the pager housing, the status light being in operational communication with the pager transmitter; and
a remote control apparatus comprising:
a remote housing, the remote housing having a remote front side, a remote back side, a remote left side, a remote right side, a remote top side, and a remote bottom side, the remote back side having a selectively removable remote battery cover;
a plurality of remote batteries coupled within the remote housing;
a microcontroller coupled within the remote housing, the microcontroller being in operational communication with the plurality of remote batteries;
a speaker coupled to the remote housing, the speaker being in operational communication with the microcontroller, the speaker being coupled adjacent a speaker grille extending through the remote back side;
a receiver coupled within the remote housing, the receiver being in operational communication with the microcontroller and in wireless communication with the pager transmitter to signal the speaker to emit a sound when the pager button is depressed;
a remote transmitter coupled within the remote housing, the remote transmitter being in operational communication with the microcontroller, the remote transmitter being configured to be in wireless communication with the television; and
a plurality of control buttons coupled to the remote housing, the plurality of control buttons being in operational communication with the microcontroller.
